(19) United States
(12) Patent Application Publication
(10) Pub. No.: US 2021/0183082 A1
(43) Pub. Date: Jun. 17, 2021

(54) IMAGE REGISTRATION METHOD, APPARATUS, COMPUTER SYSTEM, AND MOBILE DEVICE

(71) Applicant: SZ DJI TECHNOLOGY CO., LTD., Shenzhen (CN)

(72) Inventors: Hongyong ZHENG, Shenzhen (CN); Zhenbo LU, Shenzhen (CN)

(21) Appl. No.: 17/163,004

(22) Filed: Jan. 29, 2021

Related U.S. Application Data
(63) Continuation of application No. PCT/CN2018/097949, filed on Aug. 1, 2018.

(51) Int. Cl. G06T 7/33; G06T 3/00; G06T 3/40; G06K 9/46

(52) U.S. Cl. CPC G06T 7/337; G06K 9/4661; G06T 3/40; G06T 3/0068

(57) ABSTRACT

An image registration method includes determining connected domains in a first image and a second image. Each of the connected domains is a region formed by one or more pixels each having an amplitude satisfying a predetermined condition. The first image and the second image are a first original image and a second original image, respectively, or are obtained by performing a down-sampling process on the first original image and the second original image, respectively. The method further includes determining feature points in the first image and the second image according to the connected domains, and performing image registration on the first original image and the second original image according to the feature points. Each of the feature points is associated with a corresponding one of the connected domains.

### CROSS-REFERENCE TO RELATED APPLICATION

This application is a continuation of International Application No. PCT/CN2018/097949, filed Aug. 1, 2018, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of information technologies and, more particularly, to an image registration method, an apparatus, a computer system, and a mobile device.

### BACKGROUND

Image registration is a process of matching and superimposing multiple images, for example, multiple images acquired at different times, using different sensors (imaging equipment), or under different conditions (weather, illuminance, camera positions, or angles, etc.). The image registration has been widely used in remote sensing data analysis, computer vision, image processing, or other fields.

In an image registration process, feature point extraction is applied to two images to obtain feature points. Then matching feature point pairs are found through similarity measurement. Image-space coordinate transformation parameters are determined through the matching feature point pairs, and finally, the coordinate transformation parameters are used for the image registration.

The feature point extraction is a key to the image registration technology, and accurate feature point extraction provides a guarantee for the success of feature matching. Therefore, it is important to improve the accuracy of the image registration through effective feature point extraction.

### SUMMARY

In accordance with the disclosure, there is provided an image registration method including determining connected domains in a first image and a second image. Each of the connected domains is a region formed by one or more pixels each having an amplitude satisfying a predetermined condition. The first image and the second image are a first original image and a second original image, respectively, or are obtained by performing a down-sampling process on the first original image and the second original image, respectively. The method further includes determining feature points in the first image and the second image according to the connected domains, and performing image registration on the first original image and the second original image according to the feature points. Each of the feature points is associated with a corresponding one of the connected domains.

Also in accordance with the disclosure, there is provided an computer system including a memory storing computer-executable instructions and a processor configured to execute the instructions to determine connected domains in a first image and a second image. Each of the connected domains is a region formed by one or more pixels each having an amplitude satisfying a predetermined condition. The first image and the second image are a first original image and a second original image, respectively, or are obtained by performing a down-sampling process on the first original image and the second original image, respectively. The processor is further configured to execute the instructions to determine feature points in the first image and the second image according to the connected domains, and perform image registration on the first original image and the second original image according to the feature points. Each of the feature points is associated with a corresponding one of the connected domains.

### BRIEF DESCRIPTION OF THE DRAWINGS

FIG. 1 is a structural diagram of an exemplary technical solution consistent with various embodiments of the present disclosure.

FIG. 2 is a schematic structural diagram of an exemplary mobile device consistent with various embodiments of the present disclosure.

FIG. 3 is a schematic flow chart of an exemplary image registration method consistent with various embodiments of the present disclosure.

FIG. 4 is a schematic flow chart of another exemplary image registration method consistent with various embodiments of the present disclosure.

FIG. 5 is a schematic block diagram of an exemplary image registration apparatus consistent with various embodiments of the present disclosure.

FIG. 6 is a schematic block diagram of an exemplary image registration apparatus consistent with various embodiments of the present disclosure.

FIG. 7 is a schematic block diagram of an exemplary computer system consistent with various embodiments of the present disclosure.

### DETAILED DESCRIPTION OF THE EMBODIMENTS

The technical solutions in the embodiments of the present disclosure will be described below in conjunction with the drawings.

The embodiments in the present disclosure are only for helping those skilled in the art to better understand the embodiments of the present disclosure, rather than limiting the scope of the embodiments of the present disclosure.

Formulas in the embodiments of the present disclosure are only examples, and do not limit the scope of the embodiments of the present disclosure. Each formula can be modified, and these modifications should also be included in the protection scope of the present disclosure.

In the various embodiments of the present disclosure, the value of the sequence number of each process does not mean the order of execution. The execution order of each process should be determined by its function and internal logic, and should not limit the implementation process of the present disclosure.

The various implementations described in this disclosure can be implemented individually or in combination, which is not limited in the embodiments of the present disclosure.

Unless otherwise specified, all technical and scientific terms used in the embodiments of the present disclosure have the same meaning as commonly understood by those skilled in the technical field of the present disclosure. The terminology used in this disclosure is only for the purpose of describing specific embodiments, and is not intended to limit the scope of this disclosure. The term “and/or” as used in this disclosure includes any and all combinations of one or more related listed items.

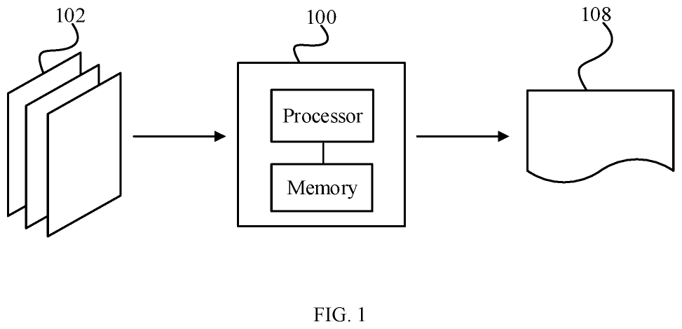

FIG. 1 is a structural diagram showing a technical solution consistent with the present disclosure.

As illustrated in FIG. 1, a system 100 receives images to be processed 102, and processes the images to be processed 102, to obtain a processing result 108. For example, the system 100 may receive two images photographed by a photographing system, and perform image registration on the two images to obtain a registration result. In some embodiments, components in the system 100 may be implemented by one or more processors. The one or more processors may be processors in a computer system or processors in a mobile device (including an unmanned aerial vehicle). The one or more processors may be any type of processor, and the present disclosure has no limit on this. The system 100 may further include one or more memories. The one or more memories may be configured to store instructions and data, for example, including computer-executable instructions for implementing the technical solutions of various embodiments of the present disclosure, the images to be processed 102, or the processing result 108. The one or more memories may be any type of memory, and the present disclosure has no limit on this.

The technical solutions of the embodiments of the present disclosure may be applied to various electronic devices, for example, including mobile devices, virtual reality (VR)/augmented reality (AR) glasses, dual-camera mobile phones, single-lens-reflection cameras, handheld mobile terminals, remote sensing satellite photographing system, or medical camera equipment. The movable devices may be unmanned aerial vehicles, unmanned boats, autonomous vehicles, robots, aerial photography systems, or aerial photography aircrafts. The present disclosure has no limit on this.

Also, the technical solutions for image registration provided by the embodiments of this disclosure can be applied to night scene noise reduction, panorama stitching, remote sensing image stitching, multi-frame image shooting and fusion, medical image enhancement, image retrieval, target recognition, or other scenes. The present disclosure has no limit on this.

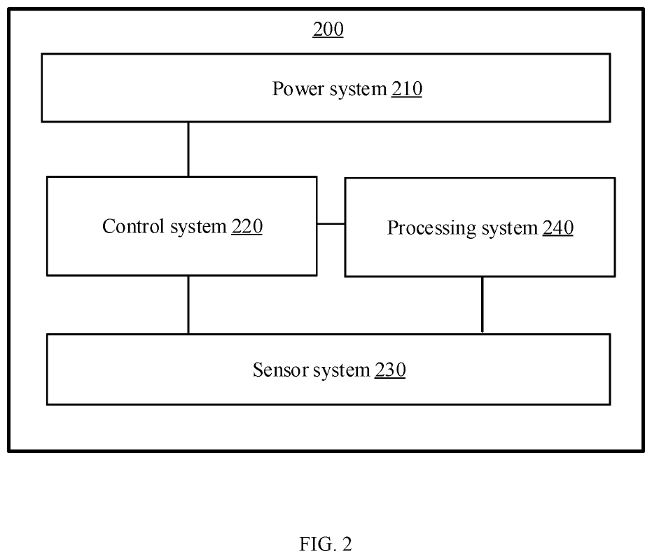

FIG. 2 illustrates an exemplary mobile device 200 consistent with the present disclosure.

As illustrated in FIG. 2, the mobile device 200 includes a power system 210, a control system 220, a sensor system 230, and a processing system 240.

The power system 210 may be configured to provide power to the mobile system 200.

For example, the mobile system 200 may be an unmanned aerial vehicle. The power system of the unmanned aerial vehicle may include an electronic governor, a propeller, and a motor corresponding to the propeller. The motor may be connected between the electronic governor and the propeller, and the motor and the propeller may be disposed on the corresponding arm. The electronic governor may be configured to receive drive signals generated by the control system, and provide drive current to the motor according to the drive signals to control rotation speed of the motor. The motor may be configured to drive the propeller to rotate, thereby providing propulsion for the flight of the unmanned aerial vehicle.

The sensor system 230 may be configured to measure attitude information of the mobile device 200, that is, position information and state information of the mobile device 200 in space, including three-dimensional position, three-dimensional angle, three-dimensional velocity, three-dimensional acceleration, and/or three-dimensional angular velocity. The sensor system 230 may, for example, include at least one of a gyroscope, an electronic compass, an inertial measurement unit (IMU), a vision sensor, a global positioning system (GPS), a barometer, or an airspeed meter.

In some embodiments, the sensor system 230 may be further configured to capture images, that is, the sensor system 230 may further include a sensor for capturing images, including a camera.

The control system 220 may be used to control the movement of the mobile device 200. The control system 220 may control the mobile device 200 according to a preset program instruction. For example, the control system 220 may control the movement of the mobile device 200 according to the attitude information of the mobile device 200 measured by the sensor system 230. The control system 220 may also control the mobile device 200 according to the control signal from the remote controller. For example, for an unmanned aerial vehicle, the control system 220 may be a flight control system (flight controller) or a control circuit in the flight controller.

The processing system 240 may be configured to process images captured by the sensor system 230. For example, the processing system 240 may include a chip such as an image signal processing (ISP) chip.

In some embodiments, the processing system 240 may be the system 100 in FIG. 1. In some other embodiments, the processing system 240 may include the system 100 in FIG. 1. The processing system 240 may be configured to implement an image registration method provided by various embodiments of the present disclosure.

The foregoing division and naming of components in the mobile system 200 are used as examples and should not be understood as limitation of the scope of the present disclosure.

The mobile device 200 may further include components not shown in FIG. 2, and the present disclosure has no limit on this.

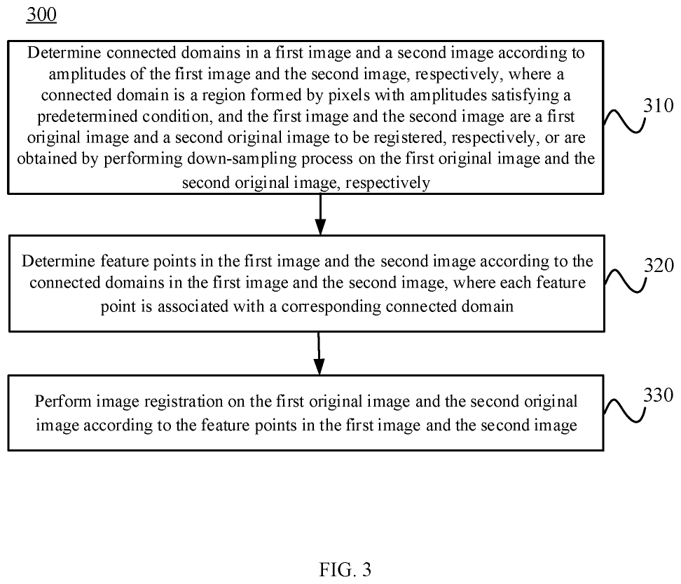

FIG. 3 illustrates an image registration method 300 consistent with the present disclosure. The method 300 may be executed by the system 100 in FIG. 1, or by the mobile device 200 in FIG. 2. Specifically, when the method 300 is executed by the mobile device 200, it may be executed by the processing system 240 in FIG. 2.

As shown in FIG. 3, at 310, connected domains of a first image and a second image are determined according to amplitudes of the first image and the second image, respectively. A connected domain is a region formed by pixels having amplitudes satisfying a predetermined condition. The first image and the second image are a first original image and a second original image, respectively, or are images obtained by down-sampling the first original image and the second original image, respectively.

In some embodiments, the first original image and the second original image may represent two images to be registered. When the first original image and the second original image are being registered, feature points may be directly extracted from the first original image and the second original image. In this scenario, the first image and the second image are the first original image and the second original image respectively. In some other embodiments, the first original image and the second original image may be down-sampled first, and then feature points may be extracted from the images formed by the down-sampling process. In this scenario, the first image and the second image are images obtained by down-sampling the first original image and the second original image, respectively.

The first original image and the second original image may be images captured by the camera system, or images obtained by preprocessing the captured images. The present disclosure has no limit on this. For example, preprocessing, such as correction of distortion, may be performed on the captured images to eliminate possible distortion in the image, and then the image registration may be performed.

In some embodiments, the feature points may be determined based on the connected domains. A connected domain may be an area formed by pixels whose amplitude meets a predetermined condition. In other words, a connected domain may be a region in the image, and the amplitude of the pixels in the region meets the predetermined condition.

The amplitude may be a value representing the image characteristic. In some embodiments, the amplitude may include at least one of gray value, brightness value, value in a saliency map, value in a feature map, color, or value in a heat map.

The saliency map may be an image that shows the uniqueness of each pixel. The goal of the saliency map is to simplify or change the representation of a general image to a style that is easier to analyze. For example, if a certain pixel has a higher grayscale in a color image, it will be displayed in a more obvious way in the saliency image. From the point of view of visual stimulation, if certain characteristics can be particularly captured by attention, such characteristics are called saliency in psychology. In other words, the saliency of an image is an important visual feature in an image, which reflects the importance of the human eye to each area of the image.

The feature map may be a feature map obtained by using a deep learning network. For example, by running a deep learning network, the feature map on a specific layer is intercepted to determine the connected domain.

Optionally, for different scenes, different amplitudes may be selected to accurately reflect the characteristics of the images.

In some embodiments, when the brightness of the ambient light in the scene corresponding to the first original image and the second original image is less than a brightness threshold, the amplitude may include a brightness value; and/or, when the brightness of the ambient light in the scene corresponding to the first original image and the second original image is not less than a brightness threshold, the amplitude may include the gray value, the value in a saliency map, or the value in a feature map.

When the brightness of the ambient light is less than the brightness threshold, that is, when the ambient light is dark, such as a night scene, the brightness can reflect the main characteristics of the night scene. Correspondingly, in the night scene, the light or other bright spots may be more prominent in the picture, which is suitable to be used as feature points. Correspondingly, the brightness value can be used as the amplitude of the connected domains. When the brightness of the ambient light is not less than the brightness threshold, that is, when the ambient light is bright, such as a daytime scene, the gray value, the value in the saliency map, or the value in the feature map can be used to reflect the amplitude of the diversified information to determine the connected domains.

Before selection, the brightness of the ambient light may be determined first, and then the selection may be performed according to the brightness of the ambient light.

The photographing system including the camera may determine the brightness of the ambient light during automatic exposure. Correspondingly, the detected brightness of the ambient light may be used directly to determine which type of amplitude can be used.

In some embodiments, when the scene corresponding to the first original image and the second original image is a fire detection scene, the amplitude may be the color or the value in the heat map.

For the detection of the fire scene, more attention may be paid to the characteristics of the fire. Correspondingly, the color or the value in the heat map may be selected as the amplitude of the connected domains.

In addition to the various amplitudes listed above, amplitudes derived from these amplitudes, or other amplitudes reflecting image characteristics, may also be used, which is not limited in the embodiments of the present disclosure.

In some embodiments, determining the connected domains may be performed directly in corresponding amplitude maps (the pixel value in the amplitude maps is amplitude). That is, the connected domains in the first image and the second image may be determined directly in the amplitude maps of the first image and the second image.

In some embodiments, the predetermined condition may include being not smaller than the amplitude threshold or being in a predetermined amplitude range.

The connected domains with desired image characteristics can be obtained through the predetermined condition. For example, the pixels in the connected domains obtained by the predetermined condition that is not less than the amplitude threshold may have higher amplitude, and therefore have more image characteristics. In some other embodiments, when the desired image characteristics correspond to a range of amplitude (that is, to exclude too low or too high amplitude points), the expected connected domains may be obtained by predetermined conditions that is in the amplitude range.

For description purposes only, the above predetermined conditions are used as examples to illustrate the present disclosure, and should not limit the scopes of the present disclosure. In some other embodiments, other predetermined conditions may be used to obtain the connected domains with the expected image characteristics. The present disclosure has no limit on this.

In some embodiments, the area of the connected domains may not be less than an area threshold.

Specifically, for the connected domains, area conditions can also be added. In other words, in addition to the condition that the amplitude of the included pixels satisfies the predetermined condition, the area of the connected domains may not be less than the area threshold. This can filter out isolated areas/points.

For example, when the amplitude is the gray value, and the predetermined condition is that the amplitude is not less than the amplitude threshold Lₜₕᵣₑₛ, the connected domains may be determined as described below.

For the first image and the second image, the gray value of each pixel in the images may be compared with Lₜₕᵣₑₛ. A point (pixel) with the gray value greater than or equal to Lₜₕᵣₑₛ may be set to 1, and a point (pixel) with gray value less than Lₜₕᵣₑₛ may be set to 0, to obtain a binary image 1 and a binary image 2.

The connected domain extraction may be performed on the binary images, and an area of each connected domain may be calculated. For each connected domain whose area is less than the area threshold Nₜₕᵣₑₛ, all pixels in this connected domain may be reset to 0 (that is, this connected domain is not considered as a final connected domain). Correspondingly, the binary amplitude map V1 and the binary amplitude map V2 after filtering out the isolated regions/points may be obtained. The connected areas of the points with the value of 1 in the binary amplitude map V1 and the binary amplitude map V2 may be determined to be the connected domains.

In some embodiments, for the first image and the second image, the connected domains corresponding to a plurality of types of amplitudes may be extracted. These connected domains are also referred to as “candidate connected domains.”

Subsequently, among the connected domains corresponding to the plurality of types of amplitude, the connected domains corresponding to one type of amplitude may be selected as the connected domains in the first image and the second image, according to a filter condition.

In some embodiments, the connected domains may be determined according to one type of amplitude, or may be determined according to the plurality of types of amplitude respectively and then one of them may be selected according to the filter condition.

Optionally, the filter condition may include a connected domain area filter condition and/or a connected domain amplitude filter condition.

For example, the connected domains may be determined according to different amplitudes simultaneously, and then the connected domain area filter condition may be used to decide. For example, when areas of the connected domains corresponding to a type of amplitude meet the connected domain area filter condition, the connected domains corresponding to this type of amplitude may be selected.

The connected domain area filter condition and/or the connected domain amplitude filter condition are used as examples to illustrate the present disclosure and in other embodiments, other filter conditions may be used. The present disclosure has no limit on this.

At 320, feature points of the first image and the second image are determined according to the connected domains of the first image and the second image. Each feature point is associated with a corresponding connected domain.

After the connected domains of the first image and the second image are obtained, the feature points may be determined according to the connected domains. Each feature point is associated with a corresponding connected domain, and the coordinates of the feature point are determined by the whole corresponding connected domain.

In some embodiments, coordinates of a center of amplitude density of each connected domain may be used as the coordinates of the corresponding feature point.

Specifically, for each connected domain, the center of the amplitude density may be determined according to a zeroth-order moment and first-order moments of the amplitude of the connected domain.

For a two-dimensional functional f (x, y), its two-dimensional (p+q)-order moment is defined as:

Mₚₐ=∫_{-∞}^{+∞}∫_{-∞}^{+∞}x^{p}y^{q}f(x,y)dxdy.

According to the foregoing definition, for a discrete amplitude map VϵR^{n×m}, its zeroth-order moment M₀₀, and two first-order moments M₁₀ and M₀₁ are respectively defined as:

$${M}_{00} = {\sum }_{i}^{n} {\sum }_{j}^{m} V ( i , j )$$

$${M}_{10} = {\sum }_{i}^{n} {\sum }_{j}^{m} i \cdot V ( i , j )$$

$${M}_{01} = {\sum }_{i}^{n} {\sum }_{j}^{m} j \cdot V ( i , j )$$

where V(i,j) is a value of an element in an i-th row and a j-th column in the amplitude map.

Correspondingly,

$$\frac{{M}_{10}}{{M}_{00}}$$

may be used to represent a center of the amplitude density of the amplitude map V in a vertical direction and describe a vertical coordinate of the center of the amplitude density.

$$\frac{{M}_{01}}{{M}_{00}}$$

may be used to represent a center of the amplitude density of the amplitude map V in a horizontal direction and describe a horizontal coordinate of the center of the amplitude density.

For each connected domain, its center of the amplitude density may be calculated according to the foregoing method. Centers of the amplitude density of all connected domains may constitute the coordinates of the feature points in the images.

When the image is scaled, the centers of the amplitude density may be relatively invariant. Assuming that the amplitude map VϵR^{n×m} is scaled by r times and the new map after scaling is V′ϵR^{rn×rm}, according to the geometric correspondence relationship of image scaling: if i′=ri, j′=rj, then V′(i′,j′)=V(ri, rj). The zeroth-order moment M′₀₀ and the two first-order moments M′₁₀ and M′₀₁ of V′ are:

$${M}_{00}^{′} = {\sum }_{i}^{rn} {\sum }_{j}^{rm} {V}^{′} ( {i}^{′} , {j}^{′} ) = {r}^{2} {\sum }_{i}^{n} {\sum }_{j}^{m} V ( i , j ) = {r}^{2} {M}_{00}$$

$${M}_{10}^{′} = {\sum }_{i}^{rn} {\sum }_{j}^{rm} {i}^{′} \cdot {V}^{′} ( {i}^{′} , {j}^{′} ) = {r}^{2} {\sum }_{i}^{n} {\sum }_{j}^{m} ri \cdot V ( i , j ) = {r}^{3} {M}_{10} \\ {M}_{01}^{′} = {\sum }_{i}^{rn} {\sum }_{j}^{rm} {j}^{′} \cdot {V}^{′} ( {i}^{′} , {j}^{′} ) = {r}^{2} {\sum }_{i}^{n} {\sum }_{j}^{m} rj \cdot V ( i , j ) = {r}^{3} {M}_{01}$$

Correspondingly, a vertical coordinate of the center of the amplitude density of the new map V′ after scaling determined by

$$\frac{{M}_{10}^{′}}{{M}_{00}^{′}}$$

may be r times of the vertical coordinate of the center of the amplitude density of the original map V. Also, a horizontal coordinate of the center of the amplitude density of the new map V′ after scaling determined by

$$\frac{{M}_{01}^{′}}{{M}_{00}^{′}}$$

may be r times of the horizontal coordinate of the center of the amplitude density of the original map V. That is, as the image is scaled by r times, the coordinates of the centers of the amplitude density may also be scaled by r times, maintaining the invariance relative to the image position. Therefore, the coordinates of the centers of the amplitude density of the connected domains can be used as the coordinates of the feature points.

In some other embodiments, the coordinates of the feature point corresponding to each connected domain may also be determined by other methods. For example, coordinates of a geometry center of each connected domain may be used as the coordinates of the corresponding feature point. The present disclosure has no limit on this.

At 330, the registration is performed on the first original image and the second original image according to the feature points in the first image and the second image.

After the feature points are obtained, the registration may be performed according to the feature points.

In some embodiments, the down-sampling process may be not performed on the first original image and the second original image. That is, the first image and the second image may be the first original image and the second original image to be registered, respectively, and the feature points in the first image and the second image may be the feature points in the first original image and the second original image. In this case, the first original image and the second original image may be registered directly according to the coordinates of the feature points.

In some other embodiments, the down-sampling process may be performed on the first original image and the second original image, respectively, to obtain the first image and the second image. For example, the down-sampling process including nearest-neighbor interpolation, bilinear interpolation, or bicubic interpolation, may be used to reduce the original images to obtain the first image and the second image. In this case, after the feature points in the first image and the second image are obtained, the coordinates of the feature points in the first image and the second image may be mapped first, to obtain the coordinates of the feature points in the first original image and the second original image. Then according to the coordinates of the feature points in the first original image and the second original image, the registration may be performed on the first original image and the second original image. For example, the coordinates of the feature points in the first image and the second image may be enlarged to obtain the coordinates of the feature points in the original size. The magnification of the enlargement processing may correspond to the magnification of the down-sampling processing.

In some embodiments, for the registration on the first original image and the second original image, a random sampling consensus algorithm (RANSAC) may be used according to the coordinates of the feature points in the first original image and the second original image, to register the first original image and the second original image. Other schemes can also be used for registration, which is not limited in the present disclosure. The following description will use the RANSAC as an example for illustration.

According to the RANSAC method, a portion of the feature points may be selected. Then, appropriate feature descriptors including feature descriptors of scale-invariant feature transform (SIFT), or fast feature point extraction and descriptor algorithm (Oriented FAST and Rotated BRIEF, ORB) for the portion of the feature points may be calculated in the first original image and the second original image, according to the application requirements, to obtain feature descriptor sets 1 and 2 of the two images.

Then feature point matching may be performed according to the feature descriptors, to form matching point pairs.

According to a preset registration model including affine transformation or projection transformation, model parameters may be fitted according to the coordinate correspondence of point pairs.

According to the iteration scheme of the RANSAC method, registration accuracy may be checked, and then inaccurate feature point pairs may be excluded and new potential feature point pairs may be added. The above processes may be repeated until the registration accuracy meets the requirements. The registration model that meets the requirements of the registration accuracy may be used as the final registration result.

In the present disclosure, the feature points may be determined according to the connected domains, and the coordinates of the feature points may have decimal precision, which may help to improve the accuracy of the registration model, thereby improving the accuracy of image registration.

Taking the centers of amplitude density as an example, the coordinates of the centers of amplitude density may be obtained after weighted averaging, such that they have decimal precision.

In particular, in image scaling, the feature points extracted by the conventional method on a small-size image can only be coordinate points with integer precision. Assuming that the small-size image is reduced by r times compared with the original image, the coordinate values of the feature points mapped to the original size may all be integer multiples of r. The detection accuracy loss may be large. In the technical solution of the embodiments of the present disclosure, the coordinates of the feature points may have decimal precision, such that after mapping back to the original image size, the accuracy of the feature point coordinates can still be guaranteed, which is beneficial to maintaining the final registration accuracy. Moreover, because the scaling process can greatly reduce the amount of calculation, the technical solution of the embodiments of the present disclosure can not only reduce the amount of calculation, but also ensure the accuracy of image registration.

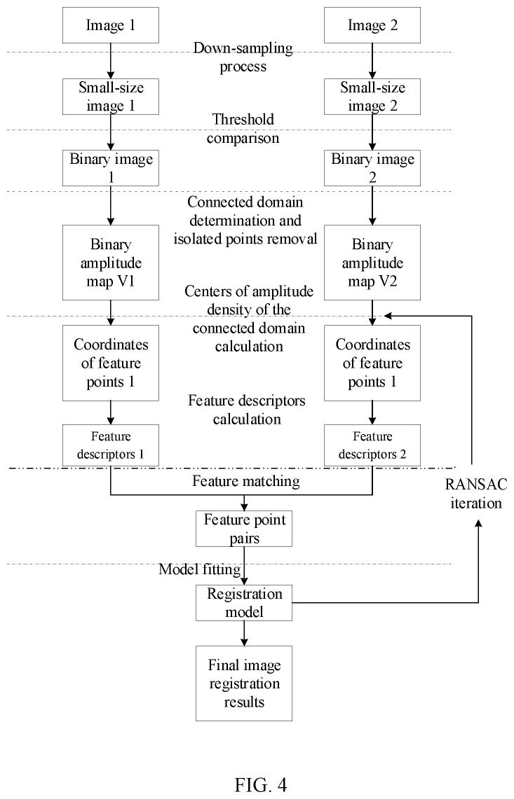

FIG. 4 is a flow chart of another exemplary image registration method according to various embodiments of the present disclosure. In the embodiment illustrated in FIG. 4, the images are scaled.

As illustrated in FIG. 4, for image 1 and image 2 to be registered, a down-sampling process is performed according to a down-sampling ratio r, to obtain small-size image 1 and small-size image 2.

For small-size image 1 and small-size image 2, based on predetermined conditions, the pixels are filtered according to the amplitude. For example, the amplitude of each pixel may be compared with the threshold Lₜₕᵣₑₛ, and the points (pixels) with the amplitude greater than or equal to Lₜₕᵣₑₛ may be set to 1, and the points with the amplitude less than Lₜₕᵣₑₛ may be set to 0. As such, binary images 1 and 2 can be obtained.

The connected domain extraction may be performed on binary images 1 and 2, and combined with the connected domain area conditions, the final connected domains may be obtained. Specifically, for a connected domain whose area is less than the area threshold Nₜₕᵣₑₛ, all pixels of this connected domain may be reset to 0, that is, this connected domain may not be considered a final connected domain. Correspondingly, a binary amplitude map V1 and a binary amplitude map V2 after filtering out isolated regions/points may be obtained.

For each connected domain in V1 and V2, the center of the amplitude density of the connected domain may be calculated. These centers of the amplitude density may constitute the coordinates of the feature points corresponding to the two images. The coordinates of the feature points may be multiplied by r to get the coordinates of the feature points in the original image size, according to the scaling relationship of r times.

The image registration may be performed using the RANSAC method, according to the coordinates of the feature points in the original image size. The detailed process may be referred to the previous illustration and will not be repeated here.

In the present disclosure, calculating on the small-size images obtained by the down-sampling process can greatly reduce the amount of calculation. Since the down-sampling process of the images has been implemented by a lot of hardware, the overall calculation amount can be reduced according to the square of the down-sampling magnification. At the same time, because the centers of the amplitude density with decimal precision are used as the coordinates of the feature points, after mapping back to the original image size, the accuracy of the coordinates of the feature points can still be guaranteed, which is helpful to maintain the final registration accuracy.

The image registration methods provided by various embodiments of the present disclosure were illustrated above. The image registration apparatus, the computer system, and the mobile device provided by the present disclosure will be described below.

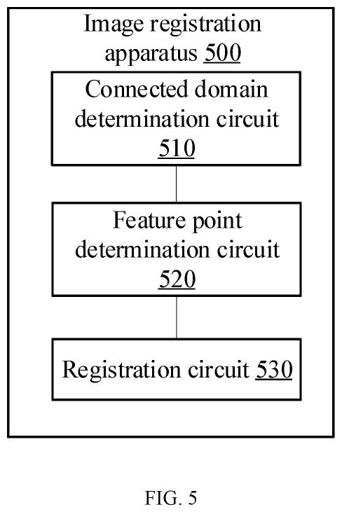

FIG. 5 illustrates an image registration apparatus 500 consistent with the present disclosure. The image registration apparatus 500 may be configured to execute image registration methods provided by various embodiments of the present disclosure.

As illustrated in FIG. 5, the apparatus 500 includes a connected domain determination circuit 510, a feature point determination circuit 520, and a registration circuit 530. The connected domain determination circuit 510 is configured to determine the connected domains in the first image and the second image respectively according to amplitudes of the first image and the second image. The connected domains are formed by pixels with the amplitude meeting predetermined conditions. The first image and the second image are first original image and the second original image, respectively, or are images obtained by performing the down-sampling process on the first original image and the second original image, respectively.

The feature point determination circuit 520 is configured to determine feature points in the first image and the second image according to the connected domains in the first image and the second image. Each feature point is associated with a corresponding connected domain.

The registration circuit 530 is configured to perform registration on the first original image and the second original image according to the feature points in the first image and the second image.

The amplitude may be a value representing the image characteristic. In some embodiments, the amplitude may include at least one of gray value, brightness value, value in a saliency map, value in a feature map, color, or value in a heat map.

In some embodiments, the feature map may be a feature map obtained by using a deep learning network.

In some embodiments, when the brightness of the ambient light in the scene corresponding to the first original image and the second original image is less than a brightness threshold, the amplitude may include a brightness value; and/or,

when the brightness of the ambient light in the scene corresponding to the first original image and the second original image is not less than a brightness threshold, the amplitude may include the gray value, the value in a saliency map, or the value in a feature map.

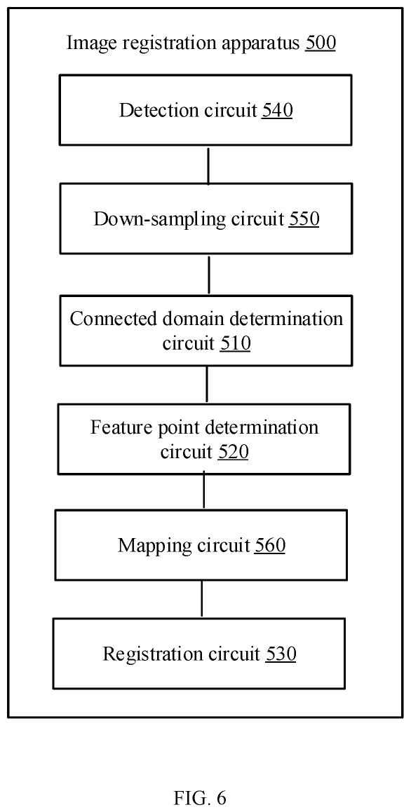

In some embodiments, as illustrated in FIG. 6, the apparatus 500 further includes a detection circuit 540 configured to detect the brightness of the ambient light in the scene.

In some embodiments, when the scene corresponding to the first original image and the second original image is a fire detection scene, the amplitude may be the color or the value in the heat map.

In some embodiments, the connected domain determination circuit 510 may be configured to determine the connected domains in the first image and the second image respectively in the amplitude maps of the first image and the second image. The pixel value in the amplitude maps of the first image and second image may be the amplitude.

In some embodiments, the predetermined condition may include being not smaller than the amplitude threshold or being in a predetermined amplitude range.

In some embodiments, the area of a connected domain may be not smaller than an area threshold.

In some embodiments, the connected domain determination circuit 510 may be configured to determine the connected domains corresponding to a plurality of types of amplitudes, and, from the connected domains corresponding to the plurality of types of amplitude, select the connected domains corresponding to one type of amplitude as the connected domains in the first image and the second image, according to a filter condition.

Optionally, the filter condition may include a connected domain area filter condition and/or a connected domain amplitude filter condition.

In some embodiments, as illustrated in FIG. 6, the apparatus 500 further includes a down-sampling circuit 550 configured to perform a down-sampling process on the first original image and the second original image respectively to obtain the first image and the second image.

In some embodiments, as illustrated in FIG. 6, the apparatus 500 further includes a mapping circuit 560 configured to perform the mapping process on the coordinates of the feature points in the first image and the second image respectively to obtain the coordinates of the feature points in the first original image and the second original image.

The registration circuit 530 may be configured to perform registration on the first original image and the second original image according to the coordinates of the feature points in the first original image and the second original image.

In some embodiments, the mapping process may be a scaling process, and the magnification of the scaling process may correspond to the magnification of the down-sampling process.

In some embodiments, the feature point determination circuit 520 may be configured to determine the coordinates of the center of the amplitude density of each connected domain as the coordinates of the corresponding feature point.

In some embodiments, the feature point determination circuit 520 may be configured to determine the center of the amplitude density of each connected domain according to the zeroth-order moment and the first-order moments of this connected domain.

In some embodiments, the feature point determination circuit 520 may be configured to determine the coordinates of the geometry center of each connected domain as the coordinates of the corresponding feature point.

In some embodiments, the down-sampling process may include: nearest-neighbor interpolation, bilinear interpolation, or bicubic interpolation.

In some embodiments, the registration circuit 530 may be configured to use a random sampling consensus algorithm (RANSA) to perform registration on the first original image and the second original image according to the coordinates of the feature points in the first original image and the second original image.

In various embodiments, the device to perform the image registration may be a chip and the chip may be implemented by circuits specifically. The processor may use the chip. The present disclosure has no limit on the specific implementation.

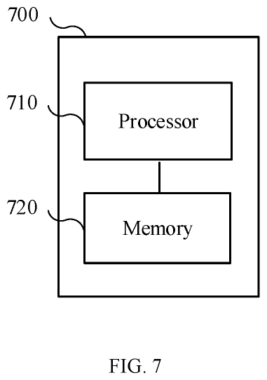

FIG. 7 illustrates a computer system 700 consistent with the present disclosure.

As illustrated in FIG. 7, the computer system 700 includes a processor 710 and a memory 720.

The computer system 700 may also include other components, such as input and output devices or communication interfaces. The present disclosure has no limit on this.

The memory 720 is configured to store computer-executable instructions.

The memory 720 may be one of various types of memory. For example, the memory 720 may include a high-speed random access memory (RAM). The memory 720 may include a non-volatile memory, such as at least one magnetic disk memory. The present disclosure has no limit on this.

The processor 710 is configured to access the memory 720 and execute the computer-executable instructions to perform operations in the image registration methods of the various embodiments of the present disclosure described above.

The processor 710 may include a microprocessor, a field-programmable gate array (FPGA), a central processing unit (CPU), or a graphics processing unit (GPU). The present disclosure has no limit on this.

The present disclosure also provides a mobile device. The mobile device may include an image registration apparatus or a computer system provided by various embodiments of the present disclosure.

The image registration apparatus, computer system, and mobile device may correspond to the execution entity of the image registration method of the present disclosure. Operations/functions of each module of the image registration apparatus, computer system and mobile device may achieve the flow process of each image registration method described above. These will not be repeated here for simplicity.

The present disclosure also provides a computer storage medium configured to store program codes. The program codes may be configured to be executed to implement the image registration method of the present disclosure.

In the embodiments of the present application, the term “and/or” is merely an association relationship describing associated objects, indicating that there may be three relationships. For example, A and/or B can mean one of three scenarios: A alone exists, A and B both exist, and B alone exists. Also, the character “/” in this text generally indicates that the associated objects before and after are in an “or” relationship.

Those of ordinary skill in the art may realize that the units and algorithm steps of the examples described in the embodiments disclosed herein can be implemented by electronic hardware, computer software, or a combination of the two, in order to clearly illustrate the hardware and software Interchangeability. In the above description, the composition and steps of each example have been generally described in accordance with the function. Whether these functions are executed by hardware or software depends on the specific application and design constraint conditions of the technical solution. Professionals and technicians can use different methods to realize the described functions for each specific application, but this realization should not be considered beyond the scope of this application.

Those skilled in the art can clearly understand that, for the convenience and conciseness of description, for the specific working process of the system, device, and unit described above, reference can be made to the corresponding process in the foregoing method embodiments, which will not be repeated here.

In the several embodiments provided in this application, the disclosed system, device, and method may be implemented in other manners. For example, the device embodiments described above are only illustrative. For example, the division of the units is only a logical function division, and there may be other divisions in actual implementation, for example, multiple units or components can be combined or can be integrated into another system, or some features can be ignored or not implemented. Also, the displayed or discussed mutual coupling or direct coupling or communication connection may be indirect coupling or communication connection through some interfaces, devices, or units, and may also be electrical, mechanical, or other forms of connection.

The units described as separate components may or may not be physically separated, and the components displayed as units may or may not be physical units, that is, they may be located in one place, or they may be distributed on multiple network units. Some or all of the units can be selected according to actual needs to achieve the objectives of the embodiments of this application.

In addition, the functional units in the various embodiments of the present application may be integrated into one processing unit, or each unit may exist alone physically, or two or more units may be integrated into one unit.

The above-mentioned integrated unit can be implemented in the form of hardware or software functional unit. If the integrated unit is implemented in the form of a software functional unit and sold or used as an independent product, it can be stored in a computer-readable storage medium. Based on this understanding, the technical solution of this disclosure or part of the technical solution can be embodied in the form of a software product. The computer software product is stored in a storage medium and includes several instructions to enable a computer device (which may be a personal computer, a server, or a network device, etc.) to execute all or part of the processes of the methods described in the various embodiments of the present disclosure. The aforementioned storage media include: a flash disk, a mobile hard disk, a read-only memory (ROM), a random access memory (RAM), magnetic disks, optical disks, or other media that can store program codes.

The above are only specific implementations of this disclosure, but the scope of this disclosure is not limited thereto. Any person skilled in the art can easily conceive various equivalent modifications or replacements within the technical scope disclosed in this disclosure. These modifications or replacements shall fall within the scope of this disclosure.

What is claimed is:

1. An image registration method comprising:
determining connected domains in a first image and a second image, each of the connected domains being a region formed by one or more pixels each having an amplitude satisfying a predetermined condition, and the first image and the second image being a first original image and a second original image, respectively, or being obtained by performing a down-sampling process on the first original image and the second original image, respectively;
determining feature points in the first image and the second image according to the connected domains, each of the feature points being associated with a corresponding one of the connected domains; and
performing image registration on the first original image and the second original image according to the feature points.

2. The method according to claim 1, wherein the amplitude includes at least one of a gray value, a brightness value, a value in a saliency map, a value in a feature map, color, or a value in a heat map.

3. The method according to claim 2, wherein:
a brightness of ambient light in a scene corresponding to the first original image and the second original image is less than a brightness threshold, and the amplitude includes the brightness value; or
the brightness of the ambient light is not less than the brightness threshold, and the amplitude includes the gray value, the value in the saliency map, or the value in the feature map.

4. The method according to claim 3, further comprising:
detecting the brightness of the ambient light.

5. The method according to claim 2, wherein:
a scene corresponding to the first original image and the second original image is a fire detection scene; and
the amplitude includes the color or the value in the heat map.

6. The method according to claim 1, wherein:
the predetermined condition includes that the amplitude is not smaller than an amplitude threshold or is in a predetermined amplitude range.

7. The method according to claim 1, wherein:
an area of each of the connected domains is not less than an area threshold.

8. The method according to claim 1, wherein determining the connected domains includes:
determining candidate connected domains corresponding to a plurality of types of amplitude in the first image and the second image; and
selecting, according to a filter condition and from the candidate connected domains, connected domains corresponding to one type of amplitude as the connected domains in the first image and the second image.

9. The method according to claim 8, wherein:
the filter condition includes at least one of a connected domain area filter condition or a connected domain amplitude filter condition.

10. The method according to claim 1,
wherein the first image and the second image are obtained by performing the down-sampling process on the first original image and the second original image, respectively;
the method further comprising:
performing down-sampling process on the first original image and the second original image to obtain the first image and the second image, respectively.

11. A computer system comprising:
a memory storing computer-executable instructions; and
a processor configured to execute the instructions to:
determine connected domains in a first image and a second image, each of the connected domains being a region formed by one or more pixels each having an amplitude satisfying a predetermined condition, and the first image and the second image being a first original image and a second original image, respectively, or being obtained by performing a down-sampling process on the first original image and the second original image, respectively;
determine feature points in the first image and the second image according to the connected domains, each of the feature points being associated with a corresponding one of the connected domains; and
perform image registration on the first original image and the second original image according to the feature points.

12. The computer system according to claim 11, wherein the amplitude includes at least one of a gray value, a brightness value, a value in a saliency map, a value in a feature map, color, or a value in a heat map.

13. The computer system according to claim 12, wherein:
a brightness of ambient light in a scene corresponding to the first original image and the second original image is less than a brightness threshold, and the amplitude includes the brightness value; or
the brightness of the ambient light is not less than the brightness threshold, and the amplitude includes the gray value, the value in the saliency map, or the value in the feature map.

14. The computer system according to claim 13, wherein the processor is further configured to execute the instructions to:
detect the brightness of the ambient light.

15. The computer system according to claim 12, wherein:
a scene corresponding to the first original image and the second original image is a fire detection scene; and
the amplitude includes the color or the value in the heat map.

16. The computer system according to claim 11, wherein:
the predetermined condition includes that the amplitude is not smaller than an amplitude threshold or is in a predetermined amplitude range.

17. The computer system according to claim 11, wherein:
an area of each of the connected domains is not less than an area threshold.

18. The computer system according to claim 11, wherein the processor is further configured to execute the instructions to:
determine candidate connected domains corresponding to a plurality of types of amplitude in the first image and the second image; and
select, according to a filter condition and from the candidate connected domains, connected domains corresponding to one type of amplitude as the connected domains in the first image and the second image.

19. The computer system according to claim 18, wherein:
the filter condition includes at least one of a connected domain area filter condition or a connected domain amplitude filter condition.

20. The computer system according to claim 11, wherein:
the first image and the second image are obtained by performing the down-sampling process on the first original image and the second original image, respectively; and
the processor is further configured to execute the instructions to perform down-sampling process on the first original image and the second original image to obtain the first image and the second image, respectively.
